(19) United States
(12) Patent Application Publication
(10) Pub. No.: US 2012/0049527 A1
(43) Pub. Date: Mar. 1, 2012

(54) SECONDARY POWER GENERATION EMPLOYING MICRO-TURBINES IN INJECTION WELL OF GEOTHERMAL POWER GENERATION SYSTEM

(76) Inventor: BINDU RAMA RAO, Laguna Niguel, CA (US)

(21) Appl. No.: 13/090,798

(22) Filed: Apr. 20, 2011

Related U.S. Application Data
(63) Continuation-in-part of application No. 12/807,168, filed on Aug. 30, 2010.

(51) Int. Cl. H02K 7/18; F03G 7/04

(52) U.S. Cl. 290/52; 60/641.2

(57) ABSTRACT

A geothermal power generation system employs a primary power turbine & generator for power generation using geothermal heat provided by the geothermal resources pumped out of the production well, and a secondary power generation turbine & generator set for power generation using geothermal resources (such as water) being returned to the ground via the injection well. In some embodiments, the pressure of water is increased before it is pumped back into the injection well where it falls down through gravity (free falling gravity). Thus high pressure water (where water is pumped to high pressure) and/or geothermal water falling freely due to gravity (gravity free falling where water is released to fall by gravity) into the injection well is used to generate secondary power employing one or more micro-turbines that ate located (held by a chain or belt) inside the injection well. Thus, using the geothermal resources (primarily water, some gas optionally and perhaps some steam) being pumped back into the injection well, secondary power is generated and captured using the secondary power generation turbine & generator set in the injection well.

### CROSS REFERENCES TO RELATED APPLICATIONS

The present patent application is based on and makes reference to U.S. non-provisional patent Ser. No. 12/807168, entitled “RENEWABLE ENERGY CONSUMPTION MANAGEMENT USING RENEWABLE ENERGY CONSUMPTION COUPONS”, filed on Aug. 30, 2010, docket number BRR2010Green1U1. The complete subject matter of this referenced United States Patent Application is hereby incorporated herein by reference, in its entirety.

### BACKGROUND

1. Technical Field

The present invention relates generally to renewable energy generation, and specifically to the use of multiple micro-turbines in the injection well of a geothermal plant for generation of secondary power.

2. Related Art

Geothermal power generation has gained popularity of late, since energy can be extracted without burning a fossil fuel such as coal, gas, or oil. Geothermal fields produce only about one-sixth of the carbon dioxide that a relatively clean natural-gas-fueled power plant produces, and very little if any, of the nitrous oxide or sulfur-bearing gases. Binary plants, which are closed cycle operations, release essentially no emissions. Geothermal energy is available 24 hours a day, 365 days a year. Geothermal power plants have average availabilities of 90% or higher, compared to about 75% for coal plants.

To setup a geothermal plant for power generation, typically the first step is to drill an injection well into hot basement rock with limited fluid content and permeability. The second step is to inject water at sufficient pressure (or temperature differential) to propagate fractures by opening existing fractures or creating new fractures in the ground. Then a production well is drilled into the fracture network intersecting as many of the flow points as possible. Finally, a turbine/generator unit is setup to generate power from the flow of geothermal (heated) water. Typically, the injection well is used only to return/re-inject the waste water (after power generation) into the ground, to complete the loop. The resulting circulation loop allows water to circulate through the enhanced reservoir in the ground along permeable pathways, picking up in situ heat. The hot water is then pumped to the surface through the production well while it is returned to the ground from the injection well.

Injection wells are essential features of geothermal plants. However, they are expensive to create, and maintain. It would be preferable if they could be used for purposes other than to return water to the ground to complete the loop. However, no such additional usage of the injection well is encountered in the geothermal industry today.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1A is a perspective block diagram of a power generation network that comprises a geothermal power generation system for power generation in a geothermal plant, wherein a set of micro-turbines are used in the injection well of the geothermal plant to generate power from gravity assisted release of cooled geothermal water.

FIG. 1B is another perspective block diagram of the power generation network of FIG. 1A that shows an injection well and production wells of a geothermal power plant that houses the geothermal power generation system, wherein the secondary power turbine & generator set is installed/located inside the injection well.

FIG. 2A is a perspective block diagram of a secondary power generation turbine set that is coupled to a management unit for management activities and to a secondary power aggregator for aggregation of power generated by a plurality of micro-turbines that are part of the secondary power generation turbine set.

FIG. 2B is a perspective block diagram of a secondary power generation turbine set that is located within a tube section inside an injection wall of a geothermal plant.

FIG. 3 is a flow chart of an exemplary method of operating a geothermal power generation system for power generation in a geothermal plant, the geothermal plant comprising a production well and an injection well.

FIG. 4 is a perspective block diagram of a power generation network that comprises a geothermal power generation system for power generation in a geothermal plant, wherein a set of micro-turbines are used in the injection well of the geothermal plant to generate power from gravity assisted release of cooled geothermal water.

### DETAILED DESCRIPTION OF THE DRAWINGS

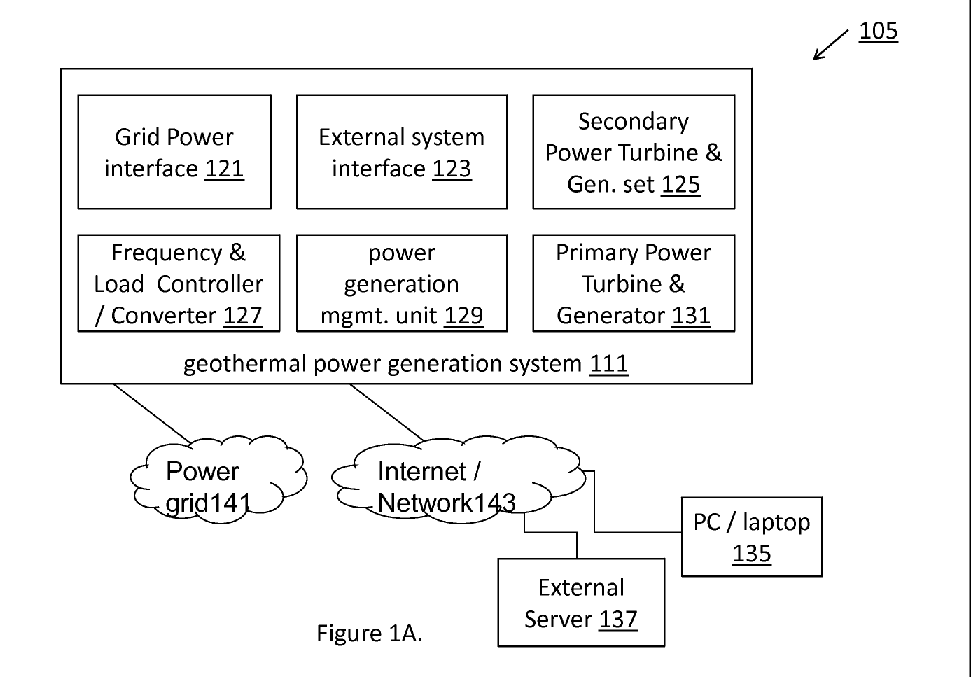

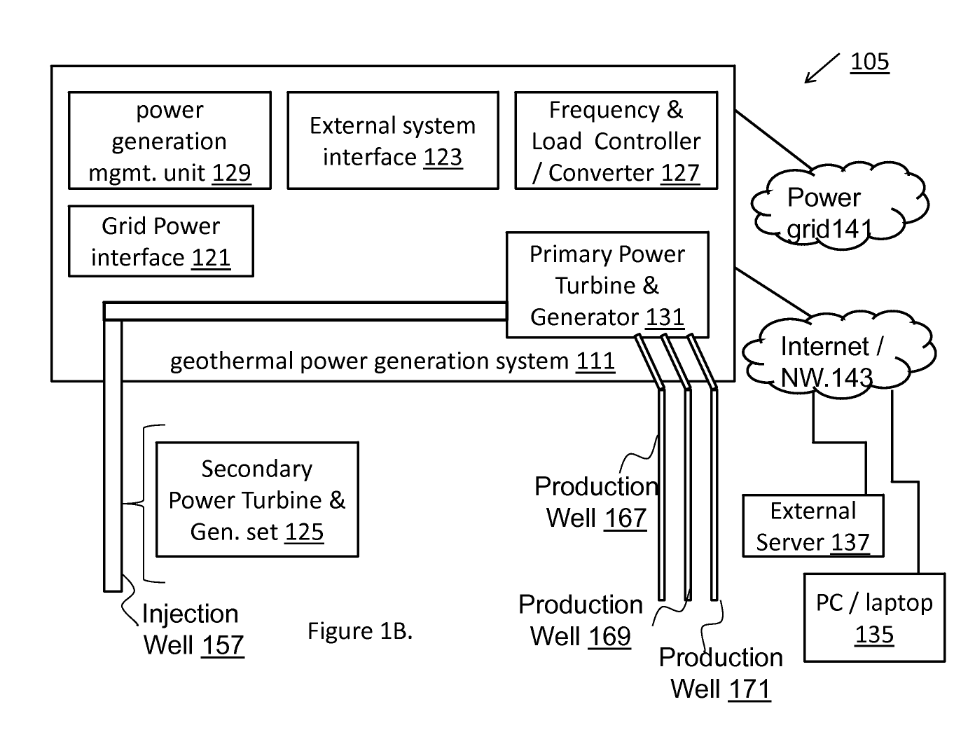

FIG. 1A is a perspective block diagram of a power generation network 105 that comprises a geothermal power generation system 111 for power generation in a geothermal plant, wherein a set of micro-turbines are used in the injection well of the geothermal plant to generate power from gravity assisted release of cooled geothermal water. The geothermal plant comprises a production well and an injection well (not shown). The geothermal power generation system 111 comprises a primary power turbine & generator 131 for generating a primary power from geothermal resources pumped out from a production well of the geothermal plant and a secondary power generation turbine & generator set 125 for generating a secondary power from the geothermal resources in an injection well of the geothermal plant. The geothermal power generation system 111 employs the primary power turbine & generator 131 for primary power generation using geothermal heat provided by the geothermal resources (such as hot water and steam) pumped out of the production well. It employs the secondary power generation turbine & generator set 125 for secondary power generation using at least one of pumped pressure geothermal resources (such as water pumped to high pressure) and gravity free falling (such as in waterfalls) geothermal resources being pumped out to the injection well. The geothermal power generation system 111 combines the primary power and the secondary power to deliver a total power from the geothermal plant.

In general, the secondary power generation turbine & generator set 125 comprises a plurality of micro-turbines that can each generate electric power from the pressurized geothermal water (pumped up to a minimum pressure if necessary) and gravity free falling geothermal water provided geothermal plant that ends up in the injection well. The plurality of micro-turbines are configured on a chain or a movable belt that is vertically disposed inside the injection well of the geothermal plant. The electrical power generated by each of the plurality of micro-turbines is collected by means of a power cable that brings the power lines out to the surface from the injection well into a frequency & load controller/converter unit 127. In general, the frequency & load controller/converter unit 127 helps keep the individual micro-turbines running at the desired frequency and voltage. The micro-turbine generators are connected to the frequency & load controller/converter unit 127, which distributes the electricity to the point of use, or a dump load. For example, the frequency & load controller/converter unit 127 senses frequency of power generated by one of the plurality of micro-turbines, and if that micro-turbine begins to go too fast, diverts some energy to the resistive load, effectively slowing the turbine to the desired speed. In most instances, some power is always flowing to the resistive load—the frequency & load controller/converter unit 127 determines almost instantly how much. In one related embodiment, each of the micro-turbines has its own onboard frequency & load controller/converter unit 127 (integrated into the micro-turbine).

In general, the geothermal power generation system 111 employs the secondary power generation turbine & generator set 125 for secondary power generation, using at least the geothermal resources pumped back into the injection well, wherein the at least the geothermal resources is optionally pumped to a changed pressure (often to a higher pressure, but sometimes to a lower pressure) before it is released into the injection well where it falls due to gravity, as it powers the movement of the plurality of micro-turbines that are part of the secondary power generation turbine & generator set 125.

The geothermal power generation system 111 also comprises a power generation management unit 129 that helps manage the power generated by each of the micro-turbines, start and stop their operations, monitor their operations, receive alerts from them, send management commands, etc. Each of the plurality of micro-turbines is communicatively coupled to a power generation management unit 129. Each of the plurality of micro-turbines is individually managed by the power generation management unit 129. Each of the plurality of micro-turbines reports an associated status information and an associated power generated information to the power generation management unit 129. A user can employ a PC/laptop 135 to access power generation related status and data provided by the power generation management unit 129. Similarly, an external server 137, with the right security credentials, can accesses the power generation related status and data provided by the power generation management unit 129

Each of the plurality of micro-turbines in the secondary power generation turbine & generator set 125 reports an alarm message based on status information, and based on conditions detected by one or more sensors associated with, or disposed on the each of the plurality of micro-turbines.

FIG. 1B is another perspective block diagram of the power generation network 105 of FIG. 1A that shows an injection well 157 and production wells 167, 169, 171 of a geothermal power plant that houses the geothermal power generation system 111, wherein the secondary power turbine & generator set 125 is installed/located inside the injection well 157. All elements in FIG. 1B have functionality similar to those described for them in FIG. 1A. The geothermal resources (hot water, steam, etc.) from the multiple production wells 167, 169, 171 are delivered to the primary power turbine & generator 131 where primary power is generated. Most of the geothermal resources are returned to the ground via the injection well 157, where the secondary power turbine & generator set 125 generates additional power employing a plurality of micro turbines located inside the injection well 157. The location of secondary power turbine & generator set 125 in the injection wall 157 of the geothermal plant is adjustable, and varies with the water pressure, water temperature, design of the inject well, the size of the borewell it uses, the height of the injection well, etc. Thus, a set of micro-turbines are used in the injection well of the geothermal plant to generate power from gravity assisted release of cooled geothermal resources (typically geothermal water, saline fluid, etc.). The geothermal plant comprises at least one production well 167, 169, 171 and at least one injection well 157.

In one embodiment, secondary power turbine & generator set 125 employs a set of the Kaplan turbines to generate the secondary power from the falling geothermal water in the injection well 157. Other types of turbines are being contemplated. In addition, a combination of different types of turbines (that use different technologies, for example) in the same secondary power turbine & generator set 125 are also being contemplated.

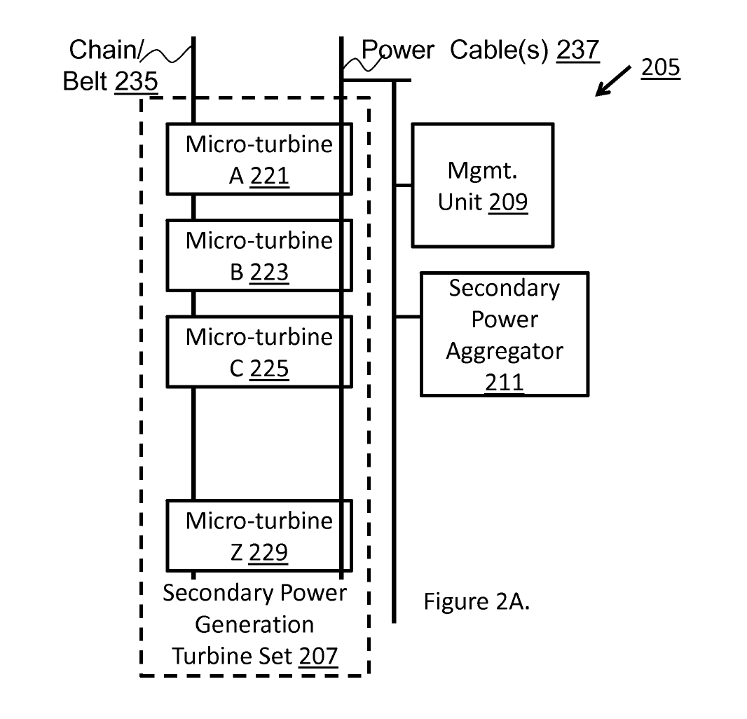

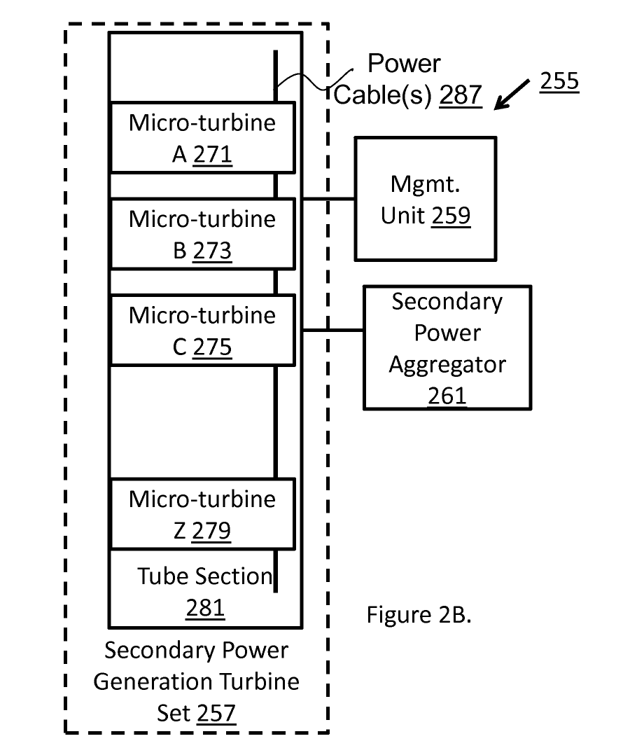

FIG. 2A is a perspective block diagram of a secondary power generation turbine set 207 that is coupled to a management unit 209 for management activities and to a secondary power aggregator 211 for aggregation of power generated by a plurality of micro-turbines that are part of the secondary power generation turbine set 207. In general, the secondary power generation turbine set 207 is located/configured inside the injection well of a geothermal plant. It can suspended by a chain/belt 235 and is anchored such that the plurality of micro-turbines 221, 223, 225, 229, that are part of the secondary power generation turbine set 207, are disposed inside the inject well. A power cable(s) 237 makes it possible to collect the power generated by the plurality of micro-turbines 221, 223, 225, 229 and deliver them to the secondary power aggregator 211. In one embodiment, the power cable(s) 237 also comprise data cables for communicating sensor data, response to management commands, alerts, etc, from the plurality of micro-turbines 221, 223, 225, 229, to the management unit 209, and management commands, etc, from the management unit 209 to the plurality of micro-turbines 221, 223, 225, 229.

In the case of a chain 235 used to locate and distribute the micro-turbines 221, 223, 225, 229 in the injection well, the plurality of micro-turbines 221, 223, 225, 229 are each attached to the chain 235, with some separation between any two adjacent ones (such as a 20 feet separation, for example). The entire chain 235 of micro-turbines can be yanked out of the injection well where they are placed for maintenance or for replacement during the operation of the geothermal plant. The chain is anchored at the top and is placed into the geothermal injection well by means of a pulley system or some such mechanical or motorized means. The entire chain of micro-turbines 221, 223, 225, 229 is retrieved out/removed from the injection well for maintenance or repairs, sometimes based on alerts or sensor data received by the management unit 209 from one or more of the micro-turbines 221, 223, 225, 229.

When a belt 235 is employed to place the micro-turbines in the injection well, each of the plurality of micro-turbines are each attached to the belt 235, and the belt 235 can be rotated inside the injection well to bring up any malfunctioning micro-turbine that needs maintenance or repairs.

In one embodiment, the plurality of micro-turbines are configured at regular intervals on a chain or a movable belt 235 inside the injection well, wherein the chain or the movable belt 235 can be withdrawn from the injection well as necessary, and reconfigured into the injection well as necessary. In general, each of the plurality of micro-turbines 221, 223, 225, 229 is replaceable.

In general, the power generated from each of the plurality of micro-turbines 221, 223, 225, 229 is aggregated to deliver the secondary power. Thus, if 10 micro-turbines are used, wherein each generates 100 W, a total of 1000 W is aggregated and delivered as the secondary power from the micro-turbines used in the injection well.

Each of the plurality of micro-turbines 221, 223, 225, 229 is individually managed by the management unit 209. Each of the plurality of micro-turbines reports an associated status information and an associated power generated information to the management unit 209.

FIG. 2B is a perspective block diagram of a secondary power generation turbine set 257 that is located within a tube section 281 inside an injection wall of a geothermal plant. The secondary power generation turbine set 207 comprises a plurality of micro-turbines 271, 273, 275, 279 that are fixed inside the tube section 281, with some distance separating them form an adjacent one. The plurality of micro-turbines 271, 273, 275, 279 are coupled to a management unit 259 for management activities and to a secondary power aggregator 261 for aggregation of power generated by a plurality of micro-turbines that are part of the secondary power generation turbine set 257.

In one embodiment, the plurality of micro-turbines 271, 273, 275, 279 are fixed equidistance from each other inside the tube section 281, and they are attached to the body of the tube section 281. A power cable(s) 287 (that also carries data and management commands) makes it possible to carry power generated by the plurality of micro-turbines 271, 273, 275, 279 out to the secondary power aggregator 261 that also provides frequency and load control. The power cable 287 is disposed along the side of the tube section 281. In one embodiment, one or more tube sections can be connected to form a long tube that is inserted into the injection well of the geothermal plant. Each of the one or more tube sections contain a set of micro-turbines 271, 273, 275, 279 that are pre-installed.

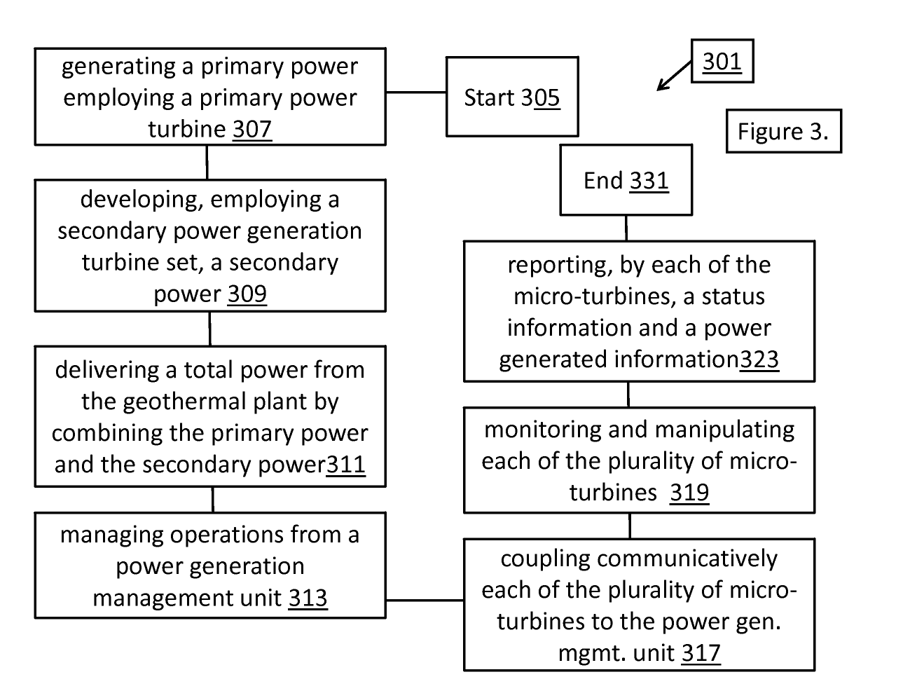

FIG. 3 is a flow chart of an exemplary method of operating a geothermal power generation system for power generation in a geothermal plant, the geothermal plant comprising a production well and an injection well. At a start block 305, the operation starts. Then, at a next block 307, the geothermal power generation system starts generating a primary power employing a primary power turbine & generator and using geothermal resources pumped out from the production well of a geothermal plant. Then, at a next block 309, it starts developing, employing a secondary power generation turbine & generator set (that comprises a plurality of micro-turbines), a secondary power from the geothermal resources in the injection well of the geothermal plant. Then, at a next block 311, it delivers a total power from the geothermal plant by combining the primary power and the secondary power.

At a next block 313, geothermal power generation system starts managing operations from a power generation management unit of the geothermal power generation system. AT a next block 317, it communicatively couples each of the plurality of micro-turbines to the power generation management unit. Then, at a next block 319, it begins monitoring and manipulating each of the plurality of micro-turbines employing the power generation management unit. At a next block 323, it facilitates reporting, by each of the plurality of micro-turbines, an associated status information and an associated power generated information to the power generation management unit. Finally, the operation terminates at an end block 331.

In one embodiment, the geothermal power generation system employs the primary power turbine & generator for power generation using geothermal heat provided by the geothermal resources pumped out of the production well and wherein the geothermal power generation system employs the secondary power generation turbine & generator set for power generation using geothermal water being returned to the ground via the injection well. In some embodiments, the pressure of water is increased before it is pumped back into the injection well where it falls down through gravity (free falling gravity). Thus high pressure water (where water is pumped to high pressure) and/or geothermal water falling freely due to gravity (gravity free falling where water is released to fall by gravity) into the injection well is used to generate secondary power employing one or more micro-turbines that ate located (held by a chain or belt) inside the injection well. Thus using the geothermal resources (primarily water, some gas optionally and perhaps some steam) being pumped back into the injection well, secondary power is generated and captured using the secondary power generation turbine & generator set in the injection well. The secondary power generation turbine & generator set comprises a plurality of micro-turbines that can each generate electric power from the at least one of pumped pressure and free falling gravity provided by the geothermal resources. The plurality of micro-turbines are configured on a chain or a movable belt that is vertically disposed inside the injection well of the geothermal plant. In one embodiment, the plurality of micro-turbines are configured at regular intervals on a chain or a movable belt and wherein the chain or the movable belt can be withdrawn from the injection well as necessary and reconfigured into the injection well as necessary. In another embodiment, each of the plurality of micro-turbines is replaceable. In addition, power generated by each of the plurality of micro-turbines is aggregated to create the secondary power.

In one embodiment, each of the plurality of micro-turbines reports an alarm message based on status information and based on conditions detected by one or more sensors associated with or disposed on the each of the plurality of micro-turbines. For example, the micro-turbines also comprise various sensors that help determine water salinity, temperature, minerals in water, gravity related parameters in surrounding rock, measurements of porosity of rocks, etc.

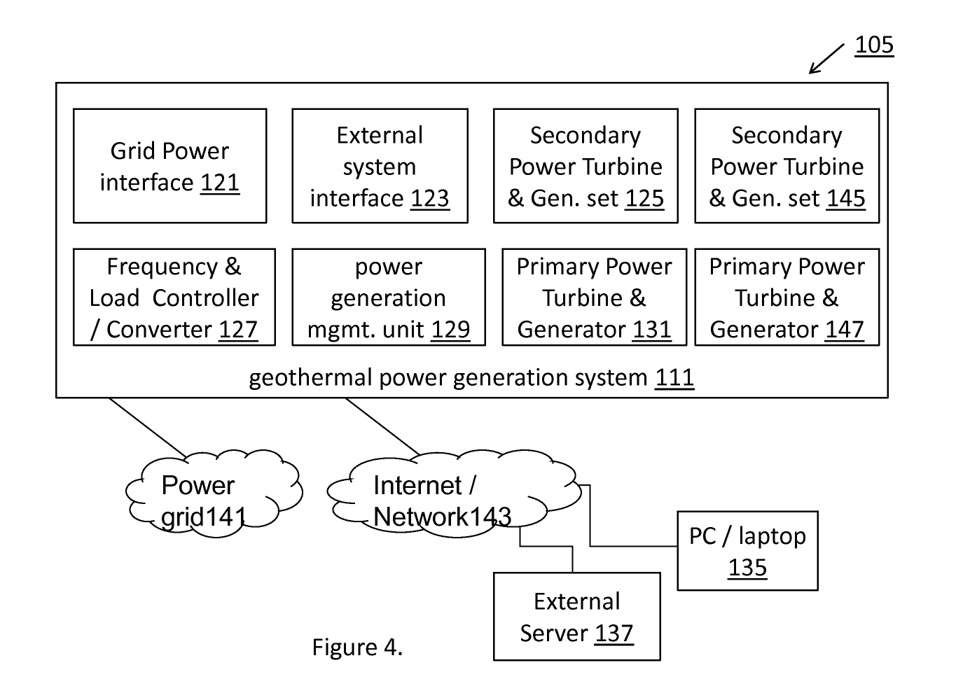

FIG. 4 is a perspective block diagram of a power generation network 105 that comprises a geothermal power generation system 111 for power generation in a geothermal plant, wherein a set of micro-turbines are used in the injection well of the geothermal plant to generate power from gravity assisted release of cooled geothermal water. The geothermal plant comprises multiple production wells and multiple injection wells (not shown). In general, all elements of the power generation network 105 are numbered the same as corresponding elements shown in FIG. 1. The like-numbered elements of FIG. 1 and FIG. 4 have the same capabilities and have similar functionalities.

However, the geothermal power generation system 111 of FIG. 4 comprises multiple primary power turbine & generators 131, 147, and multiple secondary power turbine & generator sets 125, 145. The geothermal plant comprises at least one production well (more than one in this case) and at least one injection well. It therefore also comprises at least one primary power turbine & generators for generating a primary power from geothermal resources pumped out from at least one production well of the geothermal plant. Similarly, it comprises at least one secondary power generation turbine & generator sets for generating a secondary power from the geothermal resources in the at least one injection well of the geothermal plant. Often a different secondary power generation turbine & generator set is employed for a different injection well. In one embodiment, multiple primary power turbine & generators 131, 147 are employed while a single secondary power turbine & generator sets 125 is employed.

In one embodiment, the geothermal power generation system 111 employs the at least one primary power turbine & generator for primary power generation using geothermal heat provided by the geothermal resources pumped out of the at least one production well. Similarly, the geothermal power generation system 111 employs the at least one secondary power generation turbine & generator set for secondary power generation using at least one of pumped pressure and free falling gravity provided by the geothermal resources being pumped out of the at least one injection well. It then combines the primary power and the secondary power to deliver a total power from the geothermal plant.

Each of the at least one secondary power generation turbine & generator set comprises a plurality of micro-turbines that can each generate electric power from the at least one of pumped pressure and free falling gravity provided by the geothermal resources. Similarly, each of the plurality of micro-turbines in any of the at least one secondary power generation turbine & generator set are configured on a chain or a movable belt that is vertically disposed inside the corresponding one of the at least one injection well of the geothermal plant.

Each of the plurality of micro-turbines in any of the at least one secondary power generation turbine & generator set are selected from a collection comprising axial flow turbines, radial flow turbines, Francis turbines, tubular turbines, Kaplan turbines, propeller turbines, Tyson turbines, pit turbines, straflo turbines, S-turbines, Pelton-wheel based turbines, turgo turbines, crossflow turbines and and VLH turbines. He use of other types of turbines/generators is also contemplated.

In one embodiment, the injection hole is lined with a tubing that is assembled in sections, and each section comprises one or more micro-turbines along the vertical orientation of the tube section, with power from such one or more micro-turbines drawn out and aggregated to generate the secondary power.

In one embodiment, the individual micro-turbines deployed in the borehole of an injection well also provide gravimetry services employing sensors provided to measure (over time) several parameters captured, such as gravity and flow related parameters. By comparing gravity surveys conducted automatically before and after long periods of injection, a zone of deposition of dissolved solids in brine is mapped. In addition, density changes in the surrounding walls of the injection well and changes to radius of deposition are measured and reported. The system thus computes porosity loss, fluid flow rate changes, precipitant concentration, precipitant density, fluid density, and well radius are measured/computed as necessary and then reported.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., Where one element is coupled to another element by inference) includes direct and indirect coupling between two elements in the same manner as “operably coupled” and “communicatively coupled.”

As one of ordinary skill in the art will appreciate, the terms “energy” and “power,” “electricity”, as may be used herein, include power provided to the electric grid by various types of generating stations/plants, such power also being delivered to houses and industries for consumption. The terms “renewable energy” includes power generated from biomass, solar photo-voltaic panels, geothermal plants, hydro-electric dams, wind-powered generation units, wave-powered generation units, etc.

Although the present invention has been described in terms geothermal resources, it should be clear it includes fluids such as water, saline fluids, steam mixes with water, gases retrieved along with steam and water from geothermal production wells, etc. Although generating secondary renewable energy from pumping back geothermal resources into the injection well with micro-turbines located in them is disclosed, it must be clear that the present invention also applies to other types of injection, such as injection of waste water into the ground, injection of rainwater into the ground, etc.

Although the present invention has been described in terms of micro-turbines, it must be clear that any type of turbines, of any size and capacities, that can generate power from flowing water or water falling down due to gravity in a shaft well, are also covered.

Although the present invention has been described in terms power generation plants generating renewable energy, it must be clear that the present invention also applies to other types of energy storage and distribution means.

In general, the terms “renewable energy coupon” and “renewable energy consumption coupon” are equivalent as used in this invention.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A geothermal power generation system for power generation in a geothermal plant, the geothermal plant comprising a production well and an injection well, the geothermal power generation system comprising:
a primary power turbine & generator for generating a primary power from geothermal resources pumped out from a production well of the geothermal plant;
a secondary power generation turbine & generator set for generating a secondary power from the geothermal resources in an injection well of the geothermal plant;
the geothermal power generation system employs the primary power turbine & generator for primary power generation using geothermal heat provided by the geothermal resources pumped out of the production well;
the geothermal power generation system employs the secondary power generation turbine & generator set for secondary power generation, using at least the geothermal resources pumped back into the injection well, wherein the at least the geothermal resources is optionally pumped to a changed pressure before it is released into the injection well where it descends due to gravity; and
the geothermal power generation system combining the primary power and the secondary power to deliver a total power from the geothermal plant.

2. The geothermal power generation system of claim 1 wherein the secondary power generation turbine & generator set comprises a plurality of micro-turbines that can each generate electric power from the at least the geothermal resources pumped back into the injection well.

3. The geothermal power generation system of claim 2 wherein the plurality of micro-turbines are configured on a chain or a movable belt that is vertically disposed inside the injection well of the geothermal plant.

4. The geothermal power generation system of claim 3 wherein the plurality of micro-turbines are configured at regular intervals on a chain or a movable belt and wherein the chain or the movable belt can be withdrawn from the injection well as necessary and reconfigured into the injection well as necessary.

5. The geothermal power generation system of claim 4 wherein the power generated from each of the plurality of micro-turbines is aggregated to deliver the secondary power.

6. The geothermal power generation system of claim 5 wherein each of the plurality of micro-turbines is replaceable.

7. The geothermal power generation system of claim 2 further comprising:
a power generation management unit;
each of the plurality of micro-turbines is communicatively coupled to a power generation management unit;
each of the plurality of micro-turbines is individually managed by the power generation management unit; and
each of the plurality of micro-turbines reports an associated status information and an associated power generated information.

8. The geothermal power generation system of claim 7 wherein each of the plurality of micro-turbines reports an alarm message based on status information and based on conditions detected by one or more sensors associated with or disposed on the each of the plurality of micro-turbines.

9. A method of operating a geothermal power generation system for power generation in a geothermal plant, the geothermal plant comprising a production well and an injection well, the method comprising:
generating a primary power employing a primary power turbine & generator and using geothermal resources pumped out from the production well of a geothermal plant;
developing, employing a secondary power generation turbine & generator set, a secondary power from at least the geothermal resources delivered to the injection well of the geothermal plant; and
delivering a total power from the geothermal plant by combining the primary power and the secondary power.

10. The method of claim 9 wherein the geothermal power generation system employs the primary power turbine & generator for power generation using geothermal heat provided by the geothermal resources pumped out of the production well and wherein the geothermal power generation system employs the secondary power generation turbine & generator set for power generation using at least the geothermal resources pumped back into the injection well under pressure or under free fall due to gravity.

11. The method of claim 10 wherein the secondary power generation turbine & generator set comprises a plurality of micro-turbines that can each generate electric power from the at least the geothermal resources pumped back into the injection well.

12. The method of claim 11 wherein the plurality of micro-turbines are configured on a chain or a movable belt that is vertically disposed inside the injection well of the geothermal plant.

13. The method of claim 11 wherein the plurality of micro-turbines are configured at regular intervals on a chain or a movable belt and wherein the chain or the movable belt can be withdrawn from the injection well as necessary and reconfigured into the injection well as necessary.

14. The method of claim 11 wherein the power generated from each of the plurality of micro-turbines is aggregated to deliver the secondary power.

15. The method of claim 14 wherein each of the plurality of micro-turbines is replaceable.

16. The method of claim 14 further comprising:
managing operations from a power generation management unit of the geothermal power generation system;
coupling communicatively each of the plurality of micro-turbines to the power generation management unit;
monitoring and manipulating each of the plurality of micro-turbines employing the power generation management unit; and
reporting, by each of the plurality of micro-turbines, an associated status information and an associated power generated information to the power generation management unit.

17. The method of claim 11 wherein each of the plurality of micro-turbines reports an alarm message based on status information and based on conditions detected by one or more sensors associated with, or disposed on, the each of the plurality of micro-turbines.

18. A geothermal power generation system for power generation in a geothermal plant, the geothermal plant comprising at least one production well and at least one injection well, the geothermal power generation system comprising:
at least one primary power turbines for generating a primary power from geothermal resources pumped out from at least one production well of the geothermal plant;
at least one secondary power generation turbine & generator sets for generating a secondary power from the geothermal resources in the at least one injection well of the geothermal plant;
the geothermal power generation system employs the at least one primary power turbine & generator for primary power generation using geothermal heat provided by the geothermal resources pumped out of the at least one production well;
the geothermal power generation system employs the at least one secondary power generation turbine & generator set for secondary power generation using at least the geothermal resources pumped back into the at least one injection well; and
the geothermal power generation system combining the primary power and the secondary power to deliver a total power from the geothermal plant.

19. The geothermal power generation system of claim 18 further comprising:
each of the at least one secondary power generation turbine & generator set comprises a plurality of micro-turbines that can each generate electric power from the at least the geothermal resources pumped back into the at least one injection well; and
each of the plurality of micro-turbines in any of the at least one secondary power generation turbine & generator set are configured on a chain or a movable belt that is vertically disposed inside the corresponding one of the at least one injection well of the geothermal plant.

20. The geothermal power generation system of claim 19 wherein each of the plurality of micro-turbines in any of the at least one secondary power generation turbine & generator set are selected from a collection comprising axial flow turbines, radial flow turbines, Francis turbines, tubular turbines, Kaplan turbines, propeller turbines, Tyson turbines, pit turbines, straflo turbines, S-turbines, Pelton-wheel based turbines, turgo turbines, crossflow turbines and VLH turbines.
